(19) United States
(12) Patent Application Publication
(10) Pub. No.: US 2025/0153756 A1
(43) Pub. Date: May 15, 2025

(54) MULTISTAGE SELECTIVE CART CLAMP

(71) Applicant: Lab67 Co., Las Vegas, NV (US)

(72) Inventor: David Bruce McCalib, JR., Washougal, WA (US)

(73) Assignee: Lab67 Co., Las Vegas, NV (US)

(21) Appl. No.: 18/939,750

(22) Filed: Nov. 7, 2024

Related U.S. Application Data
(60) Provisional application No. 63/548,183, filed on Nov. 11, 2023.

(51) Int. Cl. B62B 5/00; F16B 7/04

(52) U.S. Cl. CPC B62B 5/00; F16B 7/0433; B62B 2207/02

(57) ABSTRACT

An apparatus, system, and method are disclosed for joining adjacent structural tubes together. The apparatus may include a tube retention body with a pair of substantially parallel retention bolts that are inserted in substantially parallel alignment within the end portions of the adjacent structural tubes. Additionally, an alignment lock plate may be pivotally affixed to the tube retention body and may be designed to retain and lock together a pair of adjacent structural tubes in a substantially parallel relation using a toolless connector. The disclosed system may include two adjacent tubular structures joined together by the disclosed apparatus via the disclosed method.

### CROSS-REFERENCE TO RELATED APPLICATIONS

This application claims the benefit of U.S. provisional patent application Ser. No. 63/548,183, filed on Nov. 11, 2023, the contents of which are incorporated herein by reference in their entirety.

### TECHNICAL FIELD

This disclosure relates to apparatus and methods for joining together structural tube structures such as utility carts, fence panels, and scaffolding. This disclosure further pertains to apparatus and methods for joining together utility carts to move and store products, such as packages, produce, retail products and other goods used in stockroom and retail locations, as well as personal or business use for storage/movement of any material goods including food goods, mail/package delivery and inventory.

### BACKGROUND

Tubular structures such as utility carts, individually and in groups, are known to be used for moving packages in stockroom, commercial, and retail locations. In distribution systems it is common to utilize tubular frame carts for “pick to order” operations, where an associate is directed to different product storage locations and is instructed to pick items based on which delivery location they will be transported to. It is often beneficial to use one cart per delivery location and pick items to that cart for delivery location segregation.

Such carts may be grouped and moved together with tugs or forklifts, but train car connections or forklift adaptations are conventionally needed to move multiple carts together. These conventional methods are not conducive to later separating, breaking down, and storing such carts when not in use.

There exists a need for an apparatus that facilitates secured or interlocked mating and de-mating of adjacent tubular structures such as utility carts to facilitate storage and movement of such carts in groups by either an individual, a tug or pallet jack, or a robotic vehicle, and also facilitate quick and easy separation and break down of the carts for storage.

### BRIEF SUMMARY

In various embodiments, an apparatus may be used to join adjacent structural tubes together. This apparatus may include a tube retention body with a pair of substantially parallel retention bolts that are inserted in substantially parallel alignment within the end portions of the adjacent structural tubes. Additionally, an alignment lock plate may be pivotally affixed to the tube retention body and may be designed to retain and lock together a pair of adjacent structural tubes in a substantially parallel relation using a toolless connector.

In various embodiments, a system of joined adjacent tubular structures may include adjacent tubular structures with adjacent structural tubes. This system may incorporate the aforementioned apparatus, which may comprise a tube retention body with retention bolts and an alignment lock plate. The alignment lock plate may be configured to retain and lock together the adjacent structural tubes in a substantially parallel relation by means of a toolless connector.

In various embodiments, a method may be used to join two adjacent tubular structures. This method may involve inserting an apparatus, consisting of the aforementioned tube retention body and alignment lock plate, into the adjacent structural tubes. Additionally, the inner face of the alignment lock plate may be pressed flush against the adjacent structural tubes. This process may result in the locking and joining of the adjacent structural tubes in a substantially parallel relation.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A-FIG. 1F illustrate various views of a multistage selective cart clamp (MSCC) apparatus 100 in accordance with one embodiment.

FIG. 2 illustrates adjacent tubular structures locked by the MSCC 200 in accordance with one embodiment.

FIG. 3A-FIG. 3C illustrate various views of an omni-directional stackable nesting utility cart (ODSNUC) array joined by MSCCs 300 in accordance with one embodiment.

FIG. 4A and FIG. 4B illustrate engaging and locking the MSCC 400 in accordance with one embodiment.

FIG. 5 illustrates a routine 500 in accordance with one embodiment.

FIG. 6A-FIG. 6C illustrate various views of MSCC engagement with ODSNUC side walls 600 in accordance with one embodiment.

FIG. 7A-FIG. 7C illustrate various views of MSCC engagement with ODSNUC end walls 700 in accordance with one embodiment.

FIG. 8A-FIG. 8C illustrate various views of MSCC engagement with ODSNUC side walls 800 in accordance with one embodiment.

FIG. 9A-FIG. 9C illustrate various views of MSCC engagement with ODSNUC end walls 900 in accordance with one embodiment.

FIG. 10A-FIG. 10C illustrate various views of MSCC engagement with ODSNUC side walls 1000 in accordance with one embodiment.

FIG. 11A-FIG. 11C illustrate various views of MSCC engagement with ODSNUC end walls 1100 in accordance with one embodiment.

### DETAILED DESCRIPTION

A multistage selective cart clamp (MSCC) is disclosed that allows the joining or ganging together of tubular structures to facilitate grouping of such structures into static or moveable arrays. The MSCC may support a selective structural tube clamping system that allows a user to pair utility carts together selectively, based on the orientation of each cart relative to the clamp.

The MSCC may be used to connect together two or more omni-directional stackable nesting utility carts (ODSNUCs) in order to facilitate movement of the ODSNUCs as a group by a human operator, a tug or pallet jack, or a robotic delivery vehicle. ODSNUCs may allow for high-density cart storage through disassembly and nested stacking of the cart components. The rapidity of their decomposition for storage may be facilitated by the toolless operation of the disclosed MSCC which is configured to engage, lock, unlock, and disengage from grouped carts without need for additional tools.

The omni-directional stackable nesting utility cart may be referred to as an “ODSNUC,” a “utility cart,” or a “cart” throughout this application. Similarly, the multistage selective cart clamp may be referred to as an “MSCC,” a “cart clamp,” or a “clamp.”

ODSNUCs and MSCCs may primarily be used in retail distribution centers where they may be loaded with the outbound flow of materials from the distribution center in a manner in which the retail store may be restocked. The flow of materials may go to an outbound shipping lane conveyor. A human may pick boxes up and stack them in the ODSNUC. The ODSNUCs may be loaded into a shipping semi-truck. In one embodiment, thirteen rows and four columns of ODSNUCs (for a total of fifty-two ODSNUCs), may fit inside a standard 53′ trailer. Once arrived at the retail location, a driver may pull the ODSNUCs out in sequence onto a lift gate and lower them to the ground. The ODSNUCs may be designed to be 24″ wide by 48″ long by 68″ tall in order to fit through a man door.

Uses for ODSNUCs and MSCCs relate to general material handling of cases and other large or heavy items commonly found in retail restocking, beverage handling, mail handling, and other material handling roles. Once inside a retail store backroom, the carts, singularly or secured together in arrays, may be taken directly to the aisle where the cases may be unloaded directly to the shelf. Once the ODSNUC is empty, it may be taken back into the backroom and disassembled and stacked for storage. The cart decks and wheels may be stacked and nested securely on top of each other, and cart wall frames may be stacked into an assembled cart.

A stacking density of one base cart deck to seven stacked cart decks may be achieved, and one base cart deck to six tubing frames may be easily achieved, for an average 1:6 reduction in storage volume for the same footprint. Once the carts are stacked and nested, space savings of up to 600% may be achieved.

The reverse logistics of taking the carts back into the trailers may be accomplished by rolling the stacked cart decks onto the back of a long haul 53′ truck with a lift gate. Lift gates may range from 80″ wide to 89″ wide and 30″ deep to 70″ deep. However, since the carts stack vertically, roughly thirty carts may be brought up at one time with each lift gate cycle, and the long haul truck may store the carts with high density. Alternatively, multiple carts joined together with clamps may be brought up in a group.

In one embodiment, the cart may have removable walls or side panels. In another embodiment, the cart may have collapsible walls or side panels. In addition to comparisons of cost and weight between these two design directions, the major trade-off between the two is empty cart stack density versus ease of use/setup/storage. Both designs may be easy to use and stackable, and there may be advantages to each design.

Features of the MSCC may be configured to prevent relative motion between two carts connected by the MSCC, allowing the carts to be easily transported together as a group or unit. Such features may be provided to prevent relative horizontal motion and relative vertical motion between the carts, as well as motion of the MSCC with respect to the carts when secured in place, as is described in greater detail below. “Relative motion” refers to the motion of one object, such as a first cart with respect to another object, such as a second cart. It may be determined by assuming the second object is fixed, that is, that it has no motion of its own. This is done by looking at the reference frame of the second object. The reference frame is an abstract coordinate system that is used to determine the position and velocities of objects in that frame. In the real world, both objects may exhibit motion within an absolute coordinate system encompassing both while experiencing no relative motion, thus acting together as a single unit. “Relative horizontal motion” refers to relative motion in a horizontal plane, parallel with the ground or flooring over which a cart may be transported or stored. “Relative vertical motion” refers to relative motion in a vertical plane, normal to the ground or flooring over which a cart may be transported or stored.

The MSCC may thus facilitate quick, easy, toolless, and secure connection of adjacent tubular structures that include structural tubes, such as utility carts. In addition, the disclosed MSCC locks flush to the structural tubes it connects, thus presenting a low profile normal to cart motion, preventing joined cart groups from snagging on objects in their environment because of the MSCCs that connect them. Aspects of the disclosed MSCC apparatus, system, and method of use are described in detail below with respect to the illustrations provided herein.

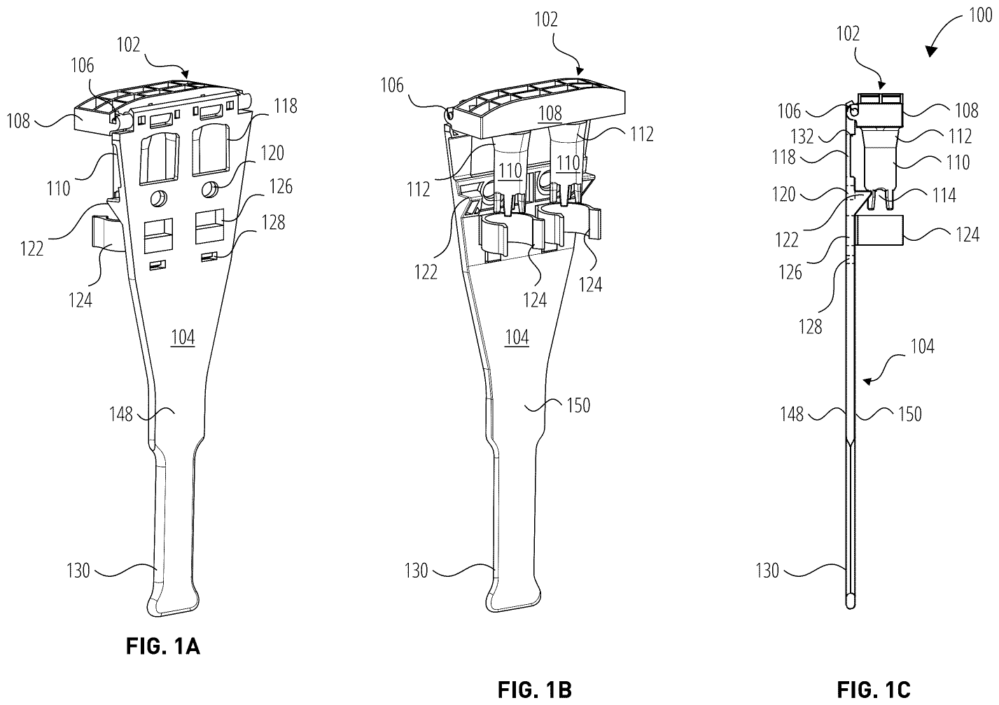

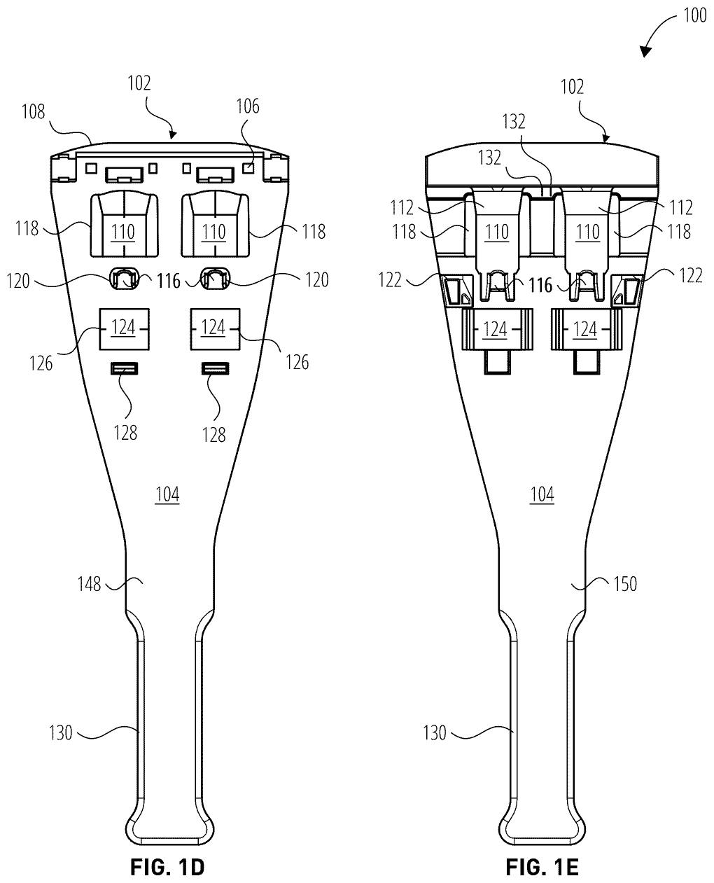

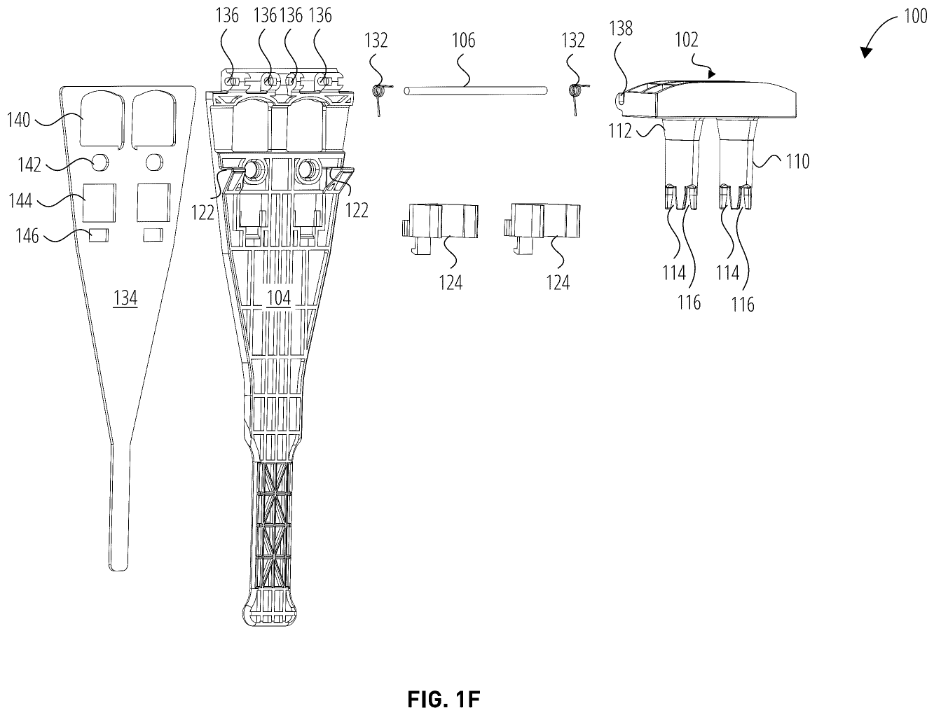

FIG. 1A-FIG. 1F illustrate various views of the MSCC apparatus 100 disclosed herein in accordance with one embodiment. FIG. 1A illustrates a perspective view of the outer face 148 of the MSCC apparatus 100. FIG. 1B illustrates a perspective view of the inner face 150 of the MSCC apparatus 100. FIG. 1C illustrates an elevation view of the side of the MSCC apparatus 100. FIG. 1D illustrates an elevation view of the outer face 148 of the MSCC apparatus 100. FIG. 1E illustrates an elevation view of the inner face 150 of the MSCC apparatus 100. FIG. 1F illustrates an exploded view of the components of the MSCC apparatus 100. For the purpose of these descriptors, “outer face” refers to the clamp face oriented away from the carts being connected and “inner face” refers to the clamp face oriented toward the carts.

The MSCC apparatus 100 may comprise a tube retention body 102 pivotally affixed to an alignment lock plate 104. For example, the tube retention body 102 may be pivotally affixed to the alignment lock plate 104 via a hinge pin 106. The tube retention body 102 may include a tube retention body head member 108 with two retention bolts 110 protruding from it. The retention bolts 110 may be configured with a frustoconical taper 112 where they adjoin the tube retention body head member 108 as shown, which may be matched by a taper within an inner bore of a structural tube and/or cross member that the retention bolts 110 engage with. The retention bolts 110 may also each be configured with a side bolt slot 114 and an end bolt slot 116, intended to engage with projecting portions of the structural tube within the structural tube. In this manner, the retention bolts 110 may seat securely within the structural tubes of carts to be connected, preventing relative horizontal motion of the carts with respect to each other.

The alignment lock plate 104 may be configured with a cross member projection securement aperture 118 configured to engage with projecting portions of the cross member at the ends of cross members of the carts connected, preventing vertical motion of the carts relative to each other when they are placed front-to-back and their cart side walls are secured with the MSCC apparatus 100. When carts are connected side-by-side with an MSCC apparatus 100 securing their cart end walls, such relative vertical motion may be prevented by the positioning of the projecting portions of the structural tubes within the structural tube projection securement apertures 120 of the MSCC apparatus 100. Where projecting portions of the structural tubes and/or projecting portions of the cross members may not be present, a securement ledge 122 included on the alignment lock plate 104 may engage with the cart cross members to prevent the clamped carts from moving vertically with respect to each other.

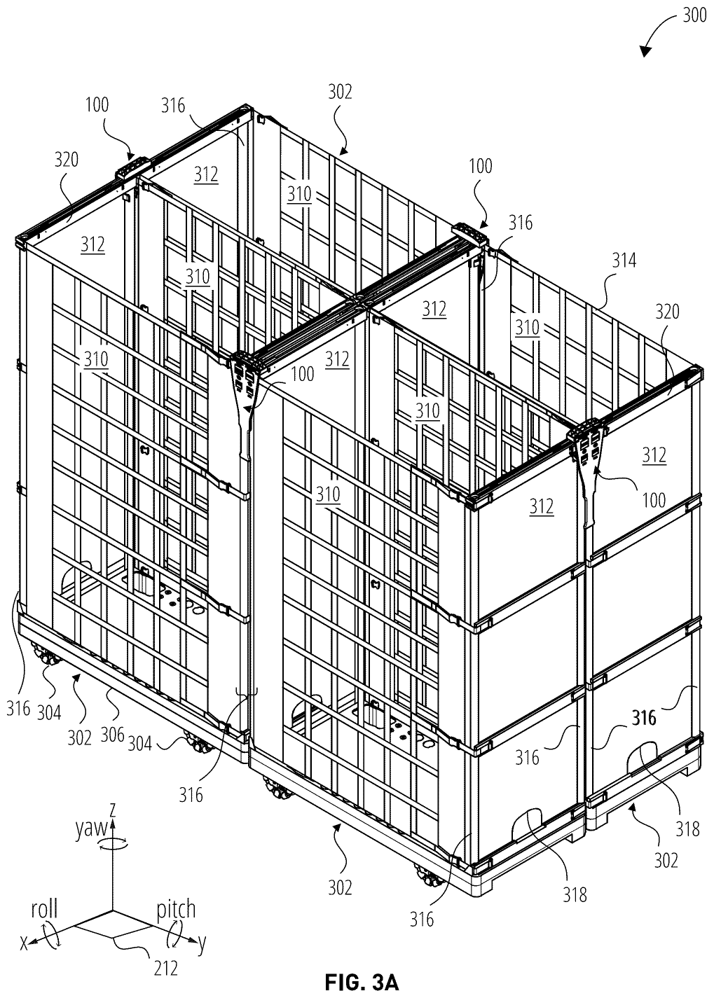

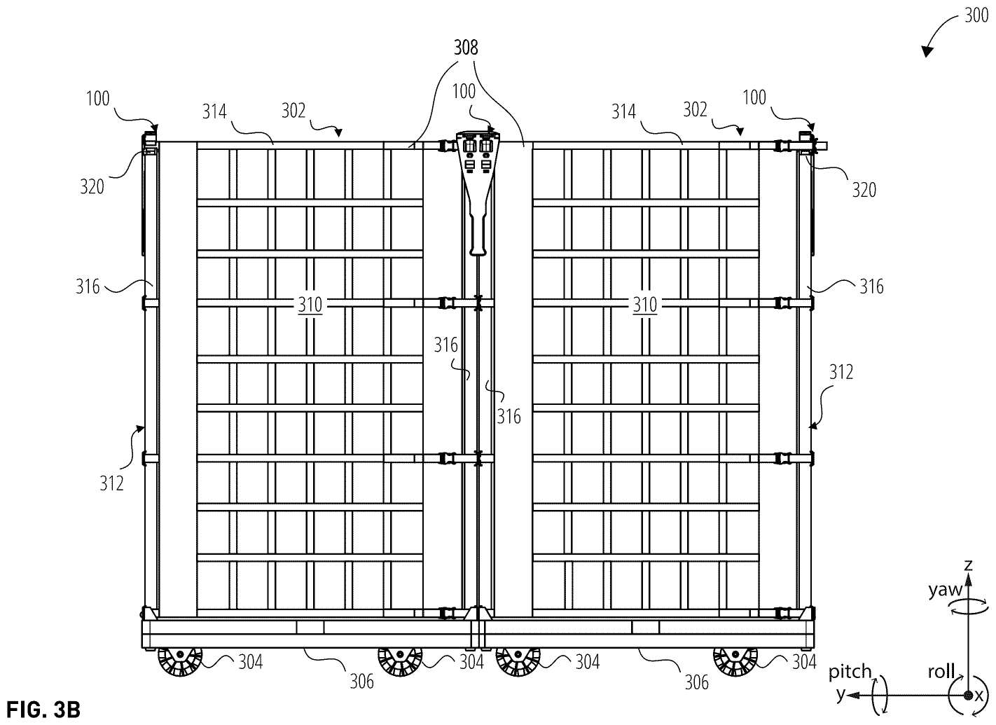

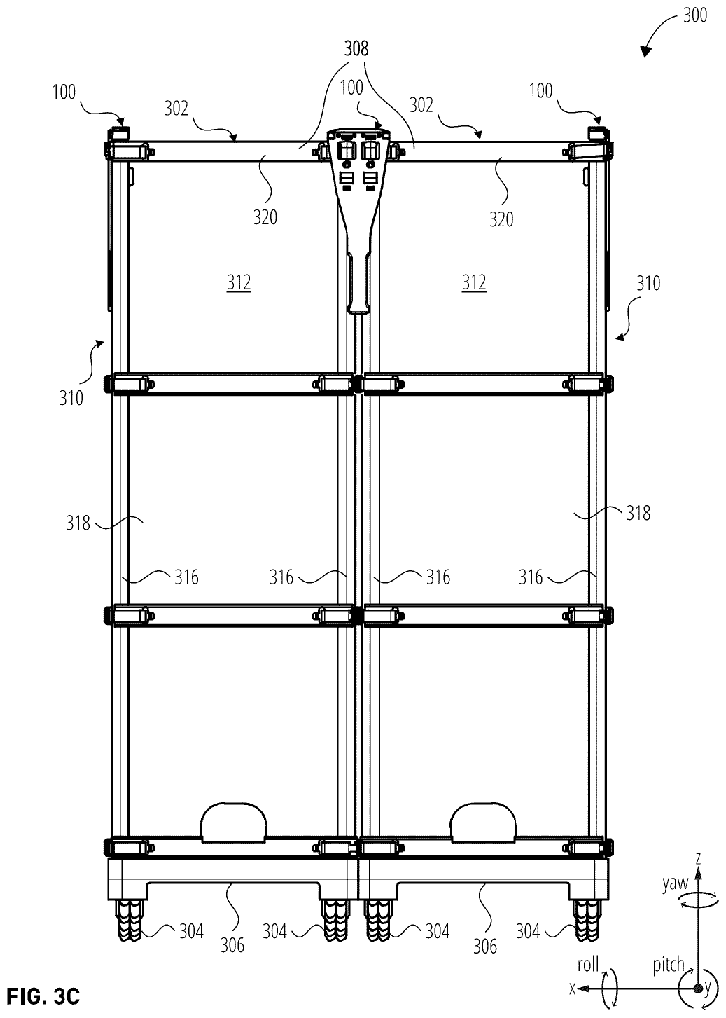

The alignment lock plate 104 may be further configured with tubing snap clips 124 which may be engaged with the cart structural tubes to prevent motion of the MSCC apparatus 100 with respect to the carts. The tubing snap clips 124 may attach to the alignment lock plate 104 by protrusions that engage with tubing snap clip securement apertures 126 and tubing snap clip securement apertures 128 configured in the alignment lock plate 104. Securement of carts using MSCC apparatus 100 is shown in greater detail with respect to FIG. 3A-FIG. 3C.

The alignment lock plate 104 may be configured with an alignment lock plate handle 130 that may be easily reached and gripped by a user. Gripping the alignment lock plate handle 130 may provide the user sufficient height and leverage to allow the user to quickly, easily, and toollessly engage the tube retention body 102 with the inner bores of the cart structural tubes in a downward motion, then press the inner face 150 of the alignment lock plate 104 flush with the structural tubes, securing the alignment lock plate 104 to the structural tubes with the tubing snap clips 124. Similarly, the user may grip the alignment lock plate handle 130 and pull outward and upward to disengage the tubing snap clips 124 and tube retention body 102 from carts when they are to be disconnected or de-mated.

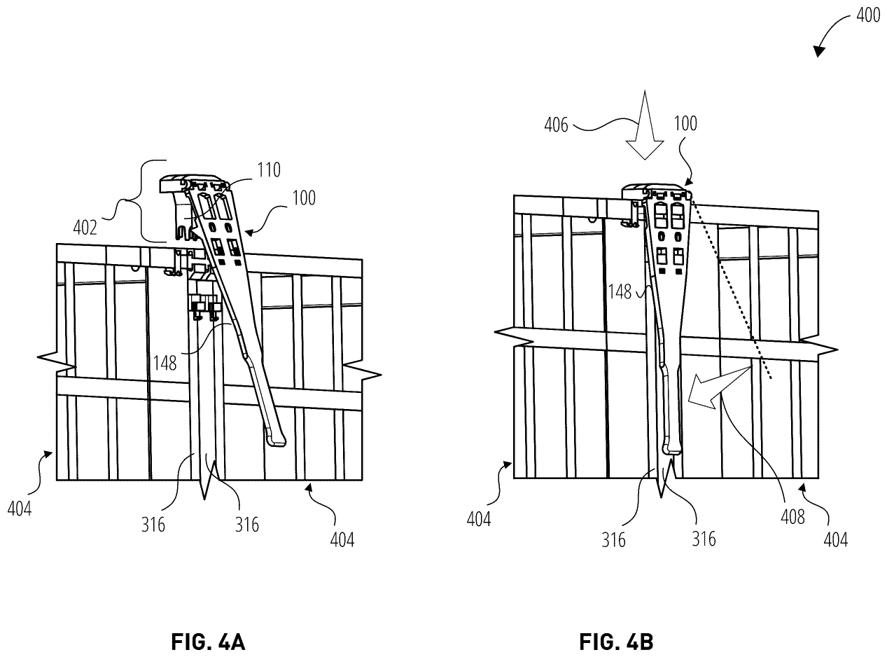

Lock springs 132 may in one embodiment provide control of the motion of the tube retention body 102 and alignment lock plate 104 with respect to each other around the hinge pin 106, keeping the MSCC apparatus 100 easy to orient, engage, and lock onto the connected carts. Engagement of the MSCC apparatus 100 to secure two carts together is shown in greater detail with respect to FIG. 4A and FIG. 4B. The ends of the lock springs 132 may engage with orifices within or may be otherwise affixed to the alignment lock plate 104 and the tube retention body 102 using methods well known in the art. The lock springs 132 may be installed in a manner such that as the hinge pin 106 is passed through alignment lock plate hinge pin apertures 136 and tube retention body hinge pin apertures 138 in order to secure the tube retention body 102 to the alignment lock plate 104, the hinge pin 106 also passes through the coils of the lock springs 132.

In one embodiment, the alignment lock plate 104 may include a metal insert 134. The metal insert 134 may provide additional durability and rigidity to the alignment lock plate 104. The metal insert 134 may be made of a heavier metal to impart more strength, or may be made of a lightweight metal to impart additional strength without adding too much weight. The metal insert 134 may include cross member projection securement cutouts 140, structural tube projection securement cutouts 142, tubing snap clip securement cutouts 144, and tubing snap clip securement cutouts 146 to accommodate the cross member projection securement apertures 118, the structural tube projection securement apertures 120, the tubing snap clip securement apertures 126, and tubing snap clip securement apertures 128 of the alignment lock plate 104. The alignment lock plate 104 may be overmolded onto or otherwise affixed to or around the metal insert 134 using various methods that are well known in the art.

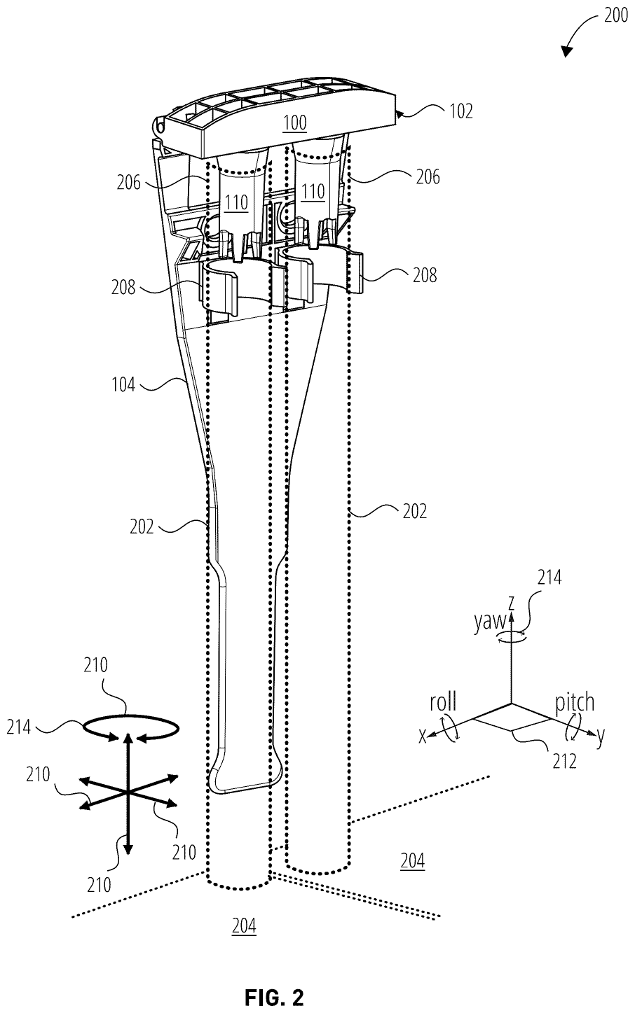

FIG. 2 illustrates an adjacent tubular structures locked by the MSCC 200 in accordance with one embodiment. The MSCC apparatus 100 is shown engaged within and locked to adjacent structural tubes 202 of adjacent tubular structures 204. The MSCC apparatus 100 may comprise a tube retention body 102 comprising a pair of substantially parallel retention bolts 110 configured to be inserted in substantially parallel aligned relation within end portions 206 of adjacent structural tubes 202 and retain the adjacent structural tubes 202. The alignment lock plate 104 pivotally affixed to the tube retention body 102 may be configured to retain and lock together the pair of adjacent structural tubes 202 in aligned substantially parallel relation via a toolless connector 208. In one embodiment the toolless connector 208 may comprise one or more tubing snap clips as illustrated in FIG. 1A-FIG. 1F.

With respect to this disclosure, “substantially parallel” refers to a configuration wherein structures such as retention bolts 110 are parallel to each other within a degree of tolerance that supports the disclosed interaction of the MSCC apparatus 100 with the adjacent structural tubes 202 of adjacent tubular structures 204, though a mathematically perfect parallel configuration of 180 degree relative orientation may not be present in all cases.

In one embodiment, the alignment lock plate 104 and the tube retention body 102 may cooperate to lock the MSCC apparatus 100 onto a pair of adjacent structural tubes 202 constrained in four degrees of freedom 210. The alignment lock plate 104 and the tube retention body 102 may cooperate to lock the MSCC apparatus 100 from translation along an X axis, a Y axis, and a Z axis, and from rotation about the Z axis 214 of each adjacent structural tube.

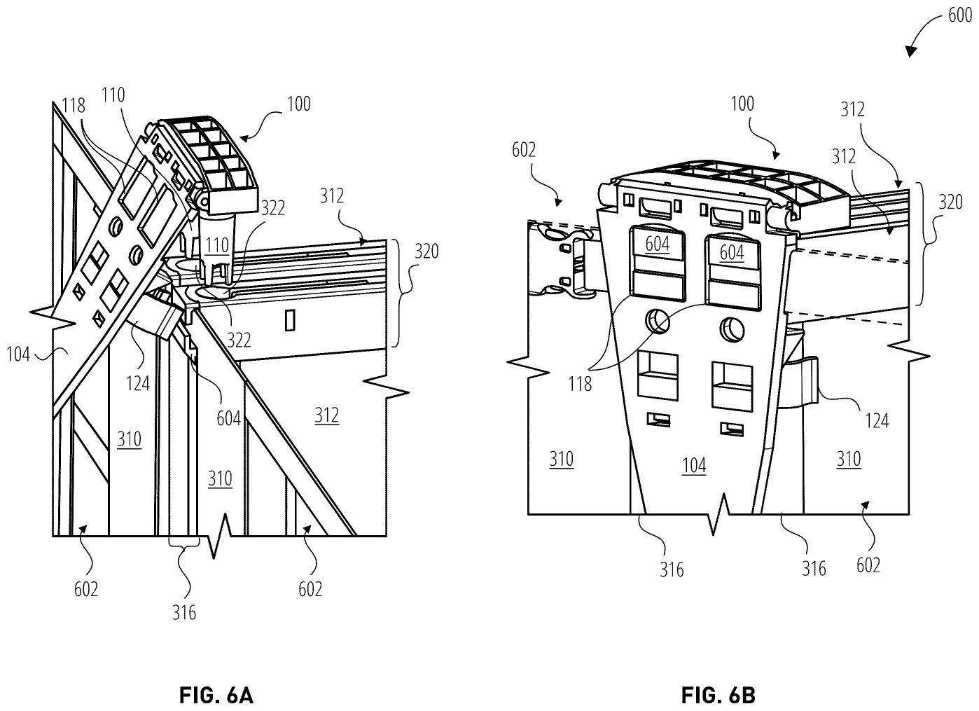

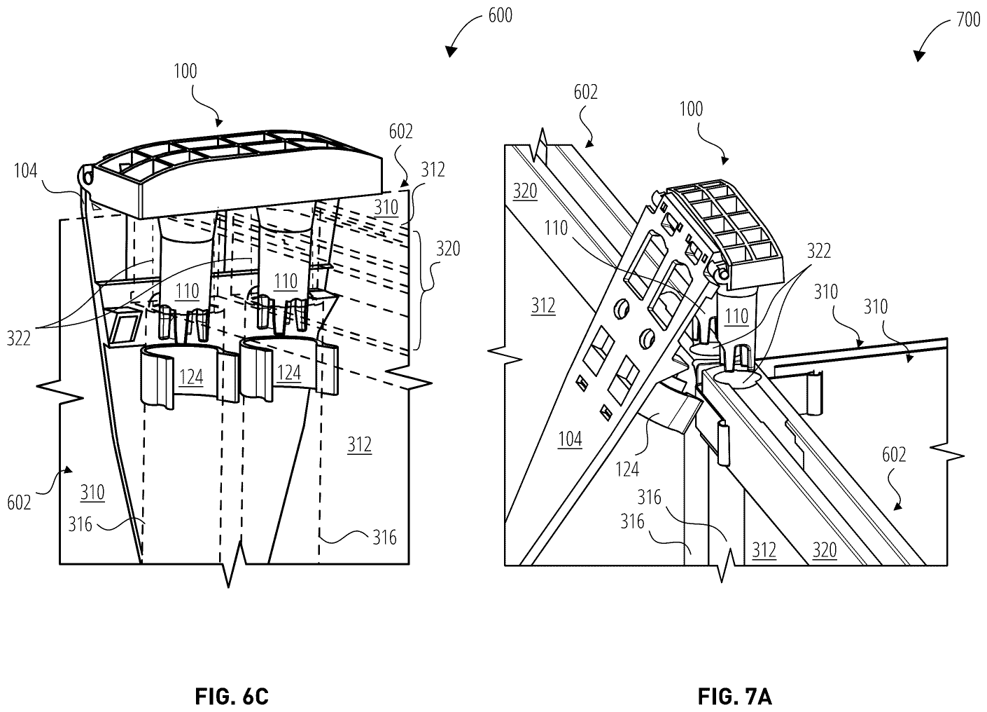

In one embodiment, each of the adjacent tubular structures 204 is a cart wall comprising at least one vertical structural tube. Such embodiments may be seen in additional detail with respect to the ODSNUC array joined by MSCCs 300 illustrated in FIG. 3A-FIG. 3C. Cooperation between the adjacent structural tubes 202 of adjacent tubular structures 204 such as adjacent cart walls may lock the rotation about the Z axis and constrain the adjacent tubular structures 204 such as adjacent cart walls along a common plane 212. In one embodiment, the alignment lock plate 104 may include a pair of apertures each configured to interlock with a projecting portion of each structural tube. This is illustrated in greater detail with respect to FIG. 6A-FIG. 11C.

FIG. 3A-FIG. 3C illustrate various views of an ODSNUC array joined by MSCCs 300 in accordance with one embodiment. FIG. 3A illustrates a perspective view of the ODSNUC array joined by MSCCs 300. FIG. 3B illustrates a side elevation view of the ODSNUC array joined by MSCCs 300. FIG. 3C illustrates an end elevation view of the ODSNUC array joined by MSCCs 300. In this array, four ODSNUCs 302 are joined together in a rectangular, two-by-two array using four MSCC apparatus 100. One of ordinary skill in the art will appreciate that arrays as small as two ODSNUCs 302 and arrays containing more than four ODSNUCs 302 may be similarly secured by an appropriate number of MSCC apparatus 100.

Each ODSNUC 302 may include omni-directional wheels 304 mounted on the bottom of a cart deck 306. The omni-directional wheels 304 may include cross rollers mounted in a ring around a rotating hub, providing two dimensions of rotational motion in along the plane of the floor our ground. The omni-directional wheels 304 may thus facilitate ease of motion of the cart in any direction across even or uneven terrain. Cutouts may be configured in the cart deck to accept the omni-directional wheels of an overlaying, rotated cart deck 306, which allows the cart decks 306 of disassembled ODSNUCs 302 to stack securely and with high stacking density in the footprint of a single ODSNUC 302.

The MSCC apparatus 100 may be configured to connect adjacent carts by coupling the vertical structural tubes 316 comprising adjacent cart walls 308. Each ODSNUC 302 may include cart side walls 310 and cart end walls 312 formed from vertical vertical structural tubes 316 and horizontal horizontal cross members 320 as shown. While each ODSNUC 302 illustrated herein includes two cart side walls 310 and two cart end walls 312, other configurations capable of being grouped and connected by MSCC apparatus 100 will be readily apprehended by one of ordinary skill in the art.

The cart side walls 310 and cart end walls 312 may be spanned by supportive structures intended to prevent cargo on the ODSNUC 302 from falling out of the cart during transport. Such structures may include mesh, webbing, netting 314, fabric backplanes 318, or other similar panel materials of a flexibility and robusticity appropriate to the cargo being secured and the anticipated roughness of transport. The cart side walls 310 are illustrated herein configured with netting 314 and the cart end walls 312 configured with fabric backplanes 318; however, one of ordinary skill in the art will appreciate that other configurations are possible.

The vertical structural tubes 316 comprising the cart side walls 310 and cart end walls 312 may be hollow. The horizontal cross members 320 may in one embodiment include cylindrical protrusions that seat within the inner diameter of the vertical structural tubes 316 they span, or may attach at the top of the vertical structural tubes 316 using some other configuration. The inner diameter of the vertical structural tubes 316 and/or the tops of the horizontal cross members 320 may present an inner bore 322 into which the retention bolts 110 of the MSCC apparatus 100 may seat. Seating and locking details of the MSCC apparatus 100 to the adjacent cart walls 308, i.e., the cart side walls 310 and/or cart end walls 312 of ODSNUCs 302 in various embodiments are illustrated in FIG. 6A-FIG. 11C.

FIG. 4A and FIG. 4B illustrate engaging and locking the MSCC 400 in accordance with one embodiment. As shown in FIG. 4A, the MSCC apparatus 100 may be placed in a pre-engaged position 402 above the vertical structural tubes 316 and/or horizontal cross members 320 (not visible in this figure) of adjacent ODSNUCs 404. In the pre-engaged position 402, the retention bolts 110 of the MSCC apparatus 100 may be aligned with the inner bores of the vertical structural tubes 316 and/or horizontal cross members 320 of the adjacent ODSNUCs 404.

As shown in FIG. 4B, a user may engage the MSCC apparatus 100 with the inner bore 322 of ODSNUC 302 vertical structural tubes 316 or horizontal cross members 320 with a downward motion 406 of the MSCC apparatus 100. The downward motion 406 may seat the retention bolts 110 of the MSCC apparatus 100 within the inner bore 322 of the adjacent ODSNUC 404 cart side walls 310 or cart end walls 312.

The MSCC apparatus 100 may next be locked to the vertical structural tubes 316 of the ODSNUCs 302 by pressing the inner face 150 of the alignment lock plate 104 against the vertical structural tubes 316 in an inward motion 408. Pressure in this inward motion 408 may engage and snaps the toolless connectors 208, such as tubing snap clips 124, of the MSCC apparatus 100 onto the vertical structural tubes 316 of the ODSNUCs 302, locking the MSCC apparatus 100 to the two adjacent ODSNUCs 302 it connects.

A number of ODSNUC 302 embodiments may be additionally secured against relative horizontal motion and relative vertical motion with respect to each other through other features configured within the MSCC apparatus 100. These features are engaged by at least one of the downward motion 406 and inward motion 408 shown here. Details of these features and there engagement are described in greater detail below.

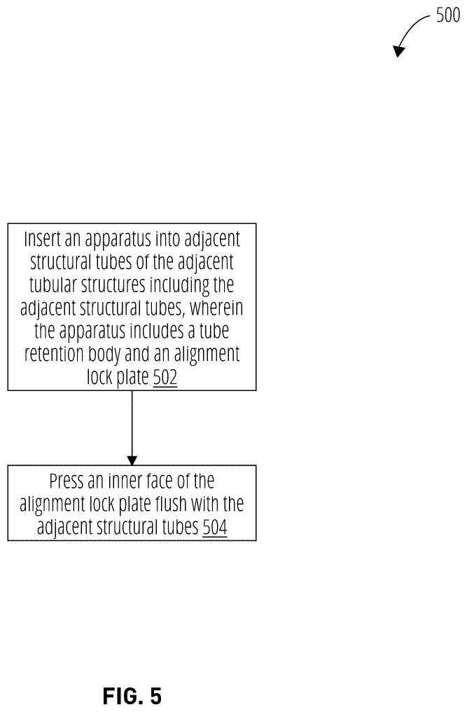

FIG. 5 illustrates an example routine 500 for forming a system of joined adjacent tubular structures by joining two adjacent tubular structures with the disclosed MSCC apparatus 100. Although the example routine 500 depicts a particular sequence of operations, the sequence may be altered without departing from the scope of the present disclosure. For example, some of the operations depicted may be performed in parallel or in a different sequence that does not materially affect the function of the routine 500. In other examples, different components of an example device or system that implements the routine 500 may perform functions at substantially the same time or in a specific sequence.

According to some examples, the method includes inserting an MSCC apparatus 100 into adjacent structural tubes of the adjacent tubular structures including the adjacent structural tubes at block 502. The tube retention body may include a pair of substantially parallel retention bolts configured to be inserted in substantially parallel aligned relation within end portions of adjacent structural tubes and retain the adjacent structural tubes. The alignment lock plate may be pivotally affixed to the tube retention body configured to retain and lock together the pair of adjacent structural tubes in aligned substantially parallel relation via a toolless connector. The actions at block 502 may be accomplished by placing the MSCC apparatus 100 into the pre-engaged position 402 introduced in FIG. 4A, then performing the downward motion 406 described with respect to that figure.

According to some examples, the method includes pressing an inner face 150 of the alignment lock plate flush with the adjacent structural tubes at block 504. In one embodiment, the alignment lock plate may lock to the pair of adjacent structural tubes may be accomplished using tubing snap clips, wherein each toolless connector is a tubing snap clip, and wherein the alignment lock plate and the tube retention body cooperate to lock the adjacent tubular structures onto a pair of adjacent structural tubes constrained in four degrees of freedom. The actions at block 504 may be accomplished by performing the inward motion 408 introduced in FIG. 4B.

FIG. 6A-FIG. 6C illustrate various views of MSCC engagement with ODSNUC side walls 600 in accordance with one embodiment. FIG. 6A illustrates a perspective view of an MSCC apparatus 100 about to engage with cart side wall 310 vertical structural tubes 316 of two ODSNUCs 602. FIG. 6B illustrates a perspective view of the outer face of the MSCC apparatus 100 fully engaged with the vertical structural tubes 316 of the two ODSNUCs 602. FIG. 6C illustrates a perspective view with transparent components showing the inner face of the MSCC apparatus 100 fully engaged with the two ODSNUCs 602.

FIG. 6A shows the MSCC apparatus 100 in the pre-engaged position as introduced with respect to FIG. 4A. The retention bolts 110 of the MSCC apparatus 100 may be seen to be above and in alignment with the inner bores 322 of the vertical structural tubes 316 and horizontal cross members 320 of two adjacent cart side walls 310 comprising two adjacent ODSNUCs 602. The ODSNUCs 602 may be seen in this figure to include horizontal cross members 320 configured with projecting portions of the cross members 604 (one of which is visible in this view). In one embodiment, the projecting portions of the cross members 604 may be structures such as tenons configured at one or more ends of the horizontal cross members 320.

FIG. 6B shows the MSCC apparatus 100 after the downward motion and inward motion introduced with respect to FIG. 4B have been completed. The retention bolts 110 are not visible in this view as they are fully seated within the inner bores 322 of the horizontal cross members 320 and vertical structural tubes 316 of the cart side walls 310. The projecting portions of the cross members 604 may be seen to protrude through the cross member projection securement apertures 118 of the MSCC apparatus 100. The tubing snap clips 124 may be seen to be snapped around and securing the vertical structural tubes 316. The MSCC apparatus 100 thus locks the two adjacent ODSNUCs 602 together securely, preventing relative horizontal motion, relative vertical motion, and rotation about a vertical axis of the two ODSNUCs 602 with respect to each other.

FIG. 6C offers another view of the MSCC apparatus 100 fully seated within and locked to the adjacent ODSNUCs 602. The vertical structural tubes 316 and horizontal cross members 320 are shown as transparent so that the seating of the retention bolts 110 within the inner bores 322 is visible. Both tubing snap clips 124 may be seen to be snapped around and securing the vertical structural tubes 316 of the adjacent ODSNUCs 602.

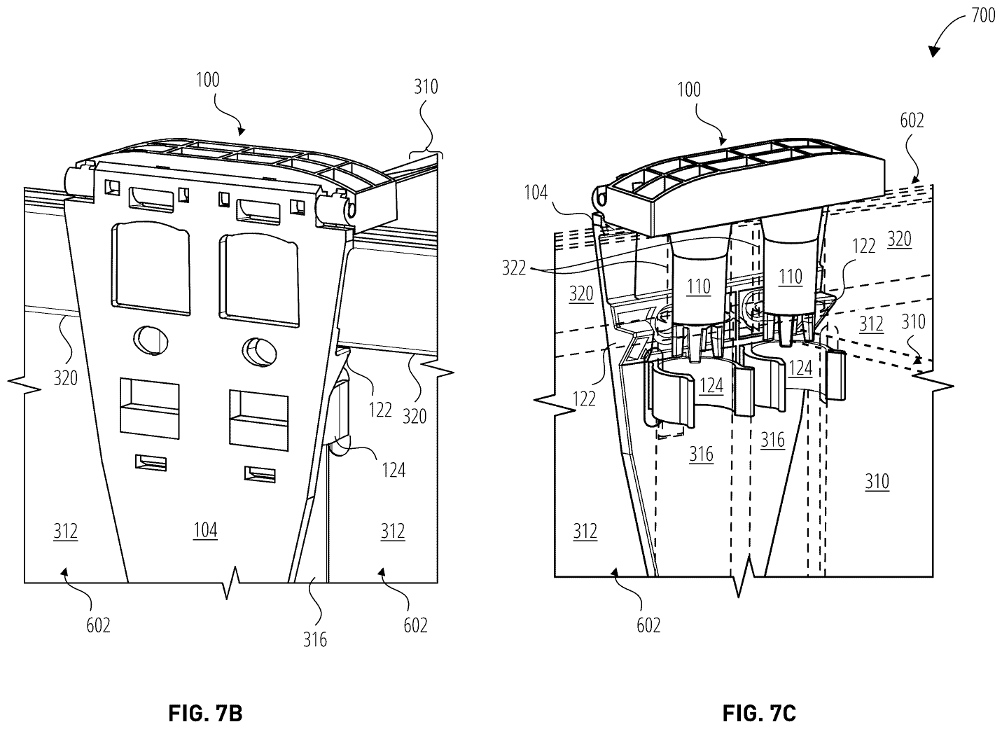

FIG. 7A-FIG. 7C illustrate various views of MSCC engagement with ODSNUC end walls 700 in accordance with one embodiment. FIG. 7A illustrates a perspective view of an MSCC apparatus 100 about to engage with cart end wall 312 vertical structural tubes 316 of two ODSNUCs 602. FIG. 7B illustrates a perspective view of the outer face of the MSCC apparatus 100 fully engaged with the vertical structural tubes 316 of the two ODSNUCs 602. FIG. 7C illustrates a perspective view with transparent components showing the inner face of the MSCC apparatus 100 fully engaged with the two ODSNUCs 602.

FIG. 7A shows the MSCC apparatus 100 in the pre-engaged position as introduced with respect to FIG. 4A. The retention bolts 110 of the MSCC apparatus 100 may be seen to be above and in alignment with the inner bores 322 of the vertical structural tubes 316 and horizontal cross members 320 of two adjacent cart end walls 312 comprising two adjacent ODSNUCs 602.

FIG. 7B shows the MSCC apparatus 100 after the downward motion and inward motion introduced with respect to FIG. 4B have been completed. The retention bolts 110 are not visible in this view as they are fully seated within the inner bores 322 of the horizontal cross members 320 and vertical structural tubes 316 of the cart end walls 312. The securement ledges 122 of the MSCC apparatus 100 protrude beneath the horizontal cross members 320. The tubing snap clips 124 are snapped around and securing the vertical structural tubes 316. The MSCC apparatus 100 thus locks the two adjacent ODSNUCs 602 together securely, preventing relative horizontal motion, relative vertical motion, and rotation about a vertical axis of the two ODSNUCs 602 with respect to each other.

FIG. 7C offers another view of the MSCC apparatus 100 fully seated within and locked to the adjacent ODSNUCs 602. The vertical structural tubes 316 and horizontal cross members 320 are shown as transparent so that the seating of the retention bolts 110 within the inner bores 322 is visible. Both tubing snap clips 124 may be seen to be snapped around and securing the vertical structural tubes 316 of the adjacent ODSNUCs 602. Both securement ledges 122 may be seen to protrude beneath and thus vertically secure the horizontal cross members 320 of both ODSNUCs 602.

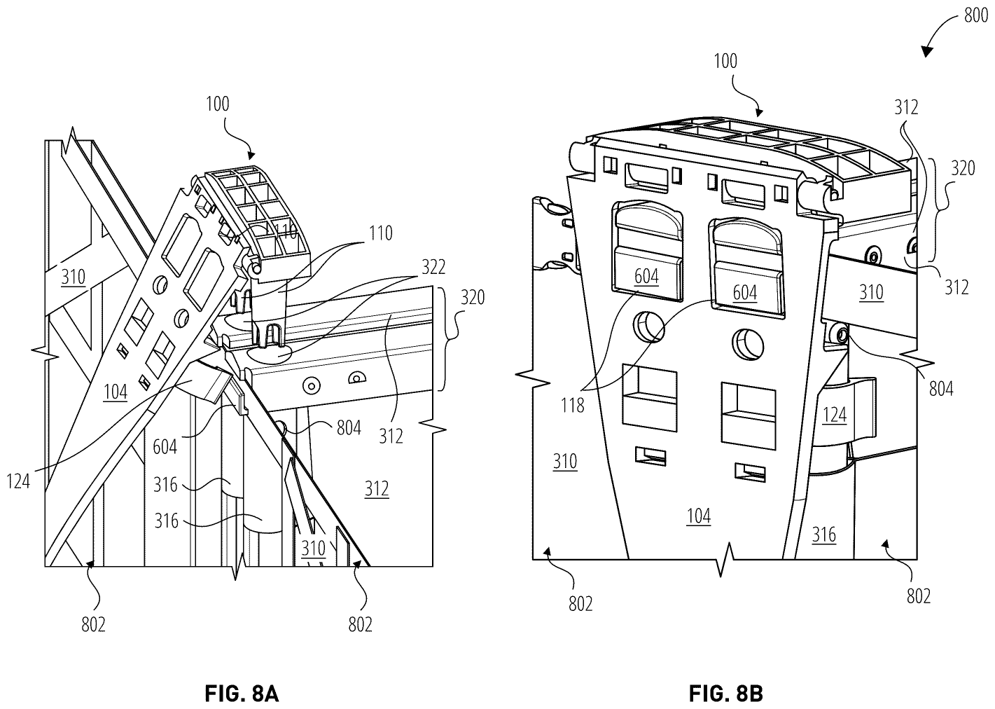

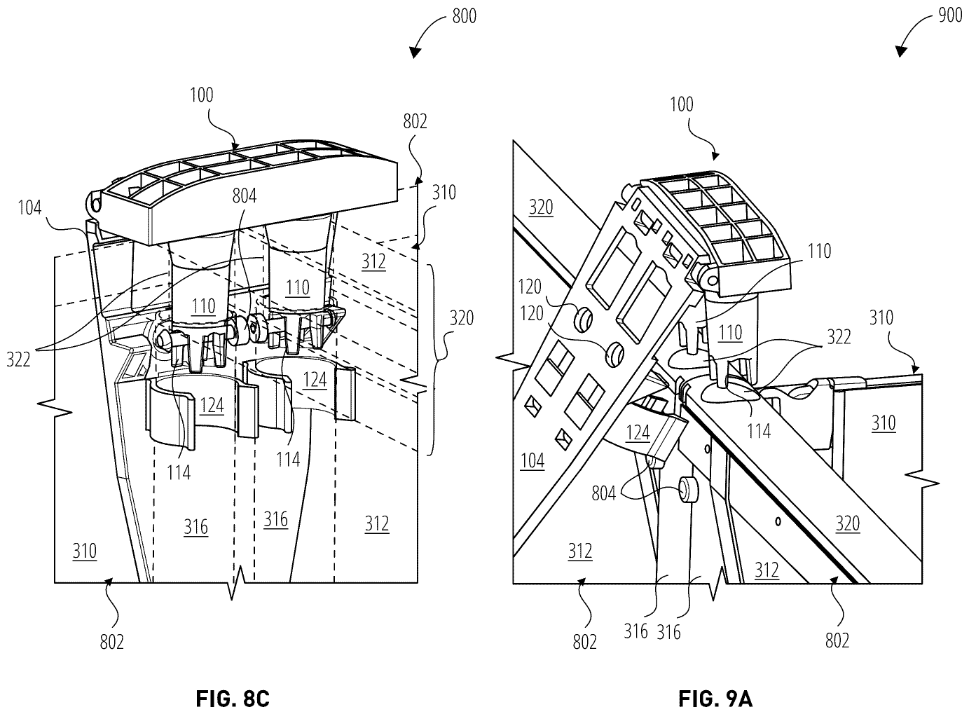

FIG. 8A-FIG. 8C illustrate various views of MSCC engagement with ODSNUC side walls 800 in accordance with one embodiment. FIG. 8A illustrates a perspective view of an MSCC apparatus 100 about to engage with cart side wall 310 vertical structural tubes 316 of two ODSNUCs 802. FIG. 8B illustrates a perspective view of the outer face of the MSCC apparatus 100 fully engaged with the vertical structural tubes 316 of the two ODSNUCs 802. FIG. 8C illustrates a perspective view with transparent components showing the inner face of the MSCC apparatus 100 fully engaged with the two ODSNUCs 802.

FIG. 8A shows the MSCC apparatus 100 in the pre-engaged position as introduced with respect to FIG. 4A. The retention bolts 110 of the MSCC apparatus 100 may be seen to be above and in alignment with the inner bores 322 of the vertical structural tubes 316 and horizontal cross members 320 of two adjacent cart side walls 310 comprising two adjacent ODSNUCs 802. The ODSNUCs 802 may be seen in this figure to include horizontal cross members 320 configured with projecting portions of the cross members 604 (one of which is visible in this view). Projecting portions of the structural tubes 804 may be seen in this ODSNUC 802 embodiment. In one embodiment, the projecting portions of the structural tubes 804 may be bolt assemblies configured along the diameter of the vertical structural tubes 316 parallel with the plane of the cart side walls 310 and normal to the plane of the cart end walls 312. with portions extending to either side each vertical structural tube 316.

FIG. 8B shows the MSCC apparatus 100 after the downward motion and inward motion introduced with respect to FIG. 4B have been completed. The retention bolts 110 are not visible in this view as they are fully seated within the inner bores 322 of the horizontal cross members 320 and vertical structural tubes 316 of the cart side walls 310. The projecting portions of the cross members 604 may be seen to protrude through the cross member projection securement apertures 118 of the MSCC apparatus 100. The tubing snap clips 124 may be seen to be snapped around and securing the vertical structural tubes 316. The MSCC apparatus 100 thus locks the two adjacent ODSNUCs 802 together securely, preventing relative horizontal motion, relative vertical motion, and rotation about a vertical axis of the two ODSNUCs 802 with respect to each other.

FIG. 8C offers another view of the MSCC apparatus 100 fully seated within and locked to the adjacent ODSNUCs 802. The vertical structural tubes 316 and horizontal cross members 320 are shown as transparent so that the seating of the retention bolts 110 within the inner bores 322 is visible. Both tubing snap clips 124 may be seen to be snapped around and securing the vertical structural tubes 316 of the adjacent ODSNUCs 802. The projecting portions of the structural tubes 804 of the ODSNUCs 802 within the vertical structural tubes 316 are accommodated by the side bolt slots 114 with which the retention bolts 110 are configured.

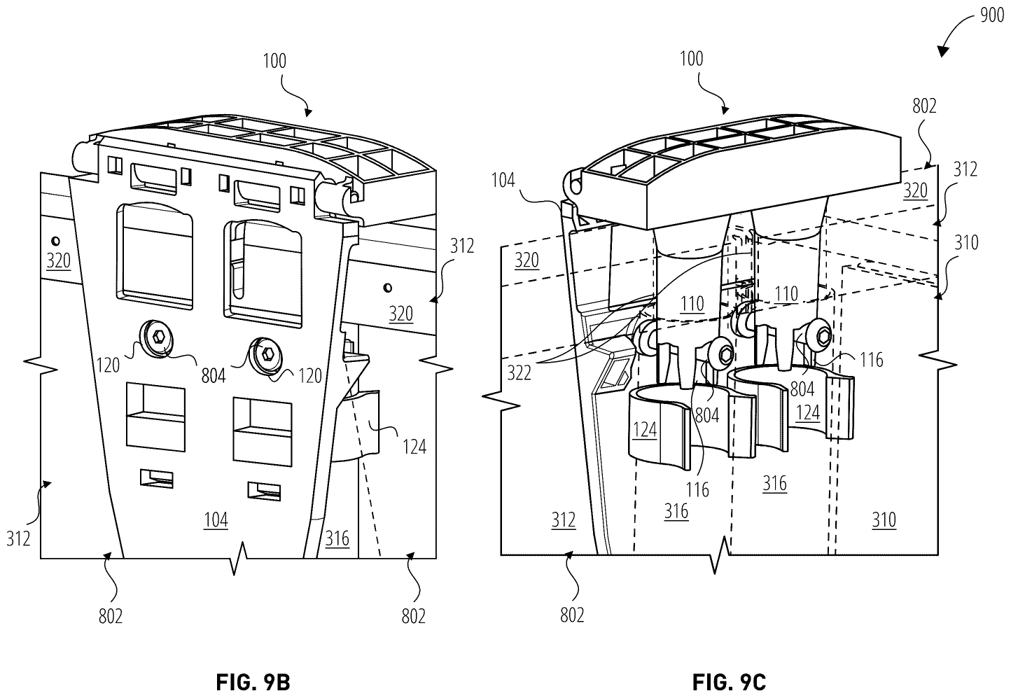

FIG. 9A-FIG. 9C illustrate various views of MSCC engagement with ODSNUC end walls 900 in accordance with one embodiment. FIG. 9A illustrates a perspective view of an MSCC apparatus 100 about to engage with cart end wall 312 vertical structural tubes 316 of two ODSNUCs 802. FIG. 9B illustrates a perspective view of the outer face of the MSCC apparatus 100 fully engaged with the vertical structural tubes 316 of the two ODSNUCs 802. FIG. 9C illustrates a perspective view with transparent components showing the inner face of the MSCC apparatus 100 fully engaged with the two ODSNUCs 802.

FIG. 9A shows the MSCC apparatus 100 in the pre-engaged position as introduced with respect to FIG. 4A. The retention bolts 110 of the MSCC apparatus 100 may be seen to be above and in alignment with the inner bores 322 of the vertical structural tubes 316 and horizontal cross members 320 of two adjacent cart end walls 312 comprising two adjacent ODSNUCs 802. Projecting portions of the structural tubes 804 may be seen in this ODSNUC 802 embodiment.

FIG. 9B shows the MSCC apparatus 100 after the downward motion and inward motion introduced with respect to FIG. 4B have been completed. The retention bolts 110 are not visible in this view as they are fully seated within the inner bores 322 of the horizontal cross members 320 and vertical structural tubes 316 of the cart end walls 312. The projecting portions of the structural tubes 804 may be seen to protrude through the structural tube may be seen to be snapped around and securing the vertical structural tubes 316. The MSCC apparatus 100 thus locks the two adjacent ODSNUCs 802 together securely, preventing relative horizontal motion, relative vertical motion, and rotation about a vertical axis of the two ODSNUCs 802 with respect to each other.

FIG. 9C offers another view of the MSCC apparatus 100 fully seated within and locked to the adjacent ODSNUCs 802. The vertical structural tubes 316 and horizontal cross members 320 are shown as transparent so that the seating of the retention bolts 110 within the inner bores 322 is visible. Both tubing snap clips 124 may be seen to be snapped around and securing the vertical structural tubes 316 of the adjacent ODSNUCs 802. The projecting portions of the structural tubes 804 of the ODSNUCs 802 within the vertical structural tubes 316 are accommodated by the end bolt slots 116 with which the retention bolts 110 are configured.

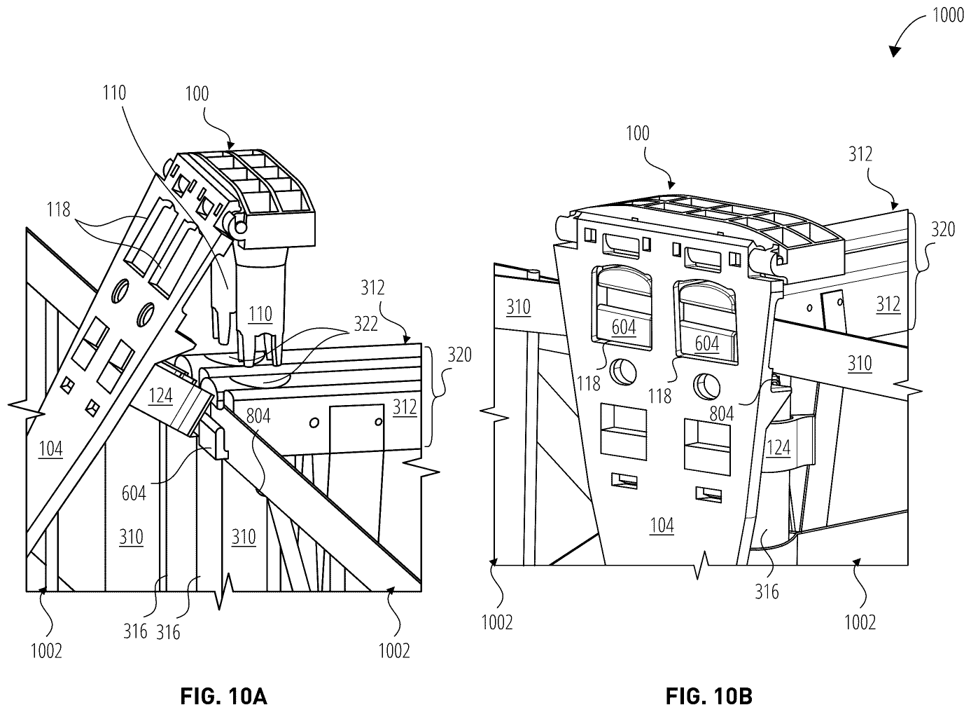

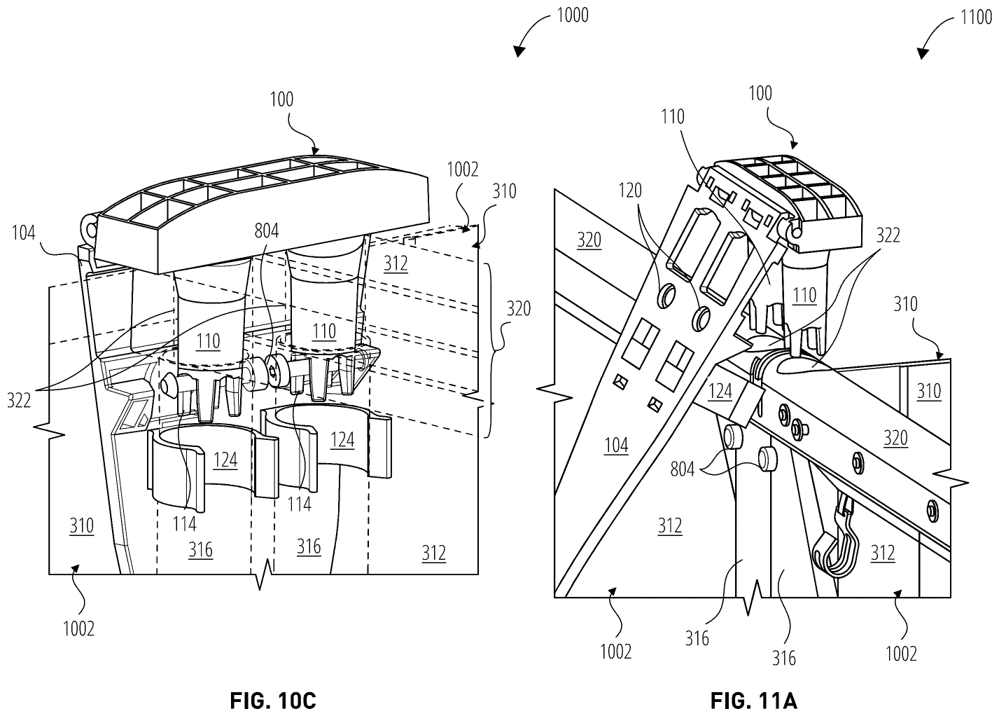

FIG. 10A-FIG. 10C illustrate various views of MSCC engagement with ODSNUC side walls 1000 in accordance with one embodiment. FIG. 10A illustrates a perspective view of an MSCC apparatus 100 about to engage with cart side wall 310 vertical structural tubes 316 of two ODSNUCs 1002. FIG. 10B illustrates a perspective view of the outer face of the MSCC apparatus 100 fully engaged with the vertical structural tubes 316 of the two ODSNUCs 1002. FIG. 10C illustrates a perspective view with transparent components showing the inner face of the MSCC apparatus 100 fully engaged with the two ODSNUCs 1002.

FIG. 10A shows the MSCC apparatus 100 in the pre-engaged position as introduced with respect to FIG. 4A. The retention bolts 110 of the MSCC apparatus 100 may be seen to be above and in alignment with the inner bores 322 of the vertical structural tubes 316 and horizontal cross members 320 of two adjacent cart side walls 310 comprising two adjacent ODSNUCs 1002. The ODSNUCs 1002 may be seen in this figure to include horizontal cross members 320 configured with projecting portions of the cross members 604 (one of which is visible in this view). Projecting portions of the structural tubes 804 may be seen in this ODSNUC 1002 embodiment.

FIG. 10B shows the MSCC apparatus 100 after the downward motion and inward motion introduced with respect to FIG. 4B have been completed. The retention bolts 110 are not visible in this view as they are fully seated within the inner bores 322 of the horizontal cross members 320 and vertical structural tubes 316 of the cart side walls 310. The projecting portions of the cross members 604 may be seen to protrude through the cross member projection securement apertures 118 of the MSCC apparatus 100. The tubing snap clips 124 may be seen to be snapped around and securing the vertical structural tubes 316. The MSCC apparatus 100 thus locks the two adjacent ODSNUCs 1002 together securely, preventing relative horizontal motion, relative vertical motion, and rotation about a vertical axis of the two ODSNUCs 1002 with respect to each other.

FIG. 10C offers another view of the MSCC apparatus 100 fully seated within and locked to the adjacent ODSNUCs 1002. The vertical structural tubes 316 and horizontal cross members 320 are shown as transparent so that the seating of the retention bolts 110 within the inner bores 322 is visible. Both tubing snap clips 124 may be seen to be snapped around and securing the vertical structural tubes 316 of the adjacent ODSNUCs 1002. The projecting portions of the structural tubes 804 of the ODSNUCs 1002 within the vertical structural tubes 316 are accommodated by the side bolt slots 114 with which the retention bolts 110 are configured.

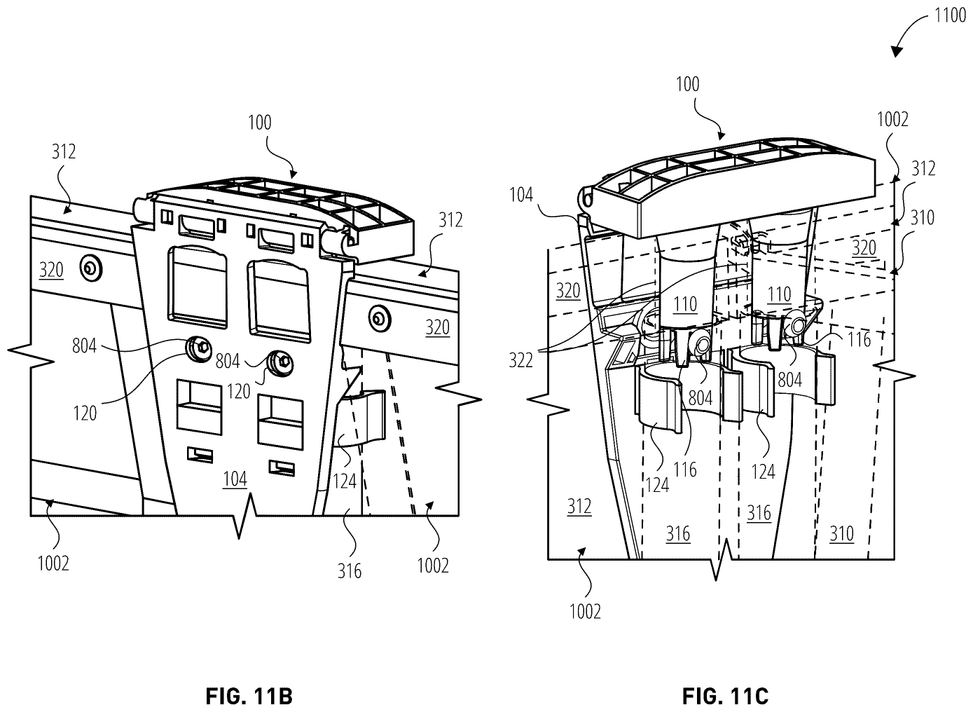

FIG. 11A-FIG. 11C illustrate various views of MSCC engagement with ODSNUC end walls 1100 in accordance with one embodiment. FIG. 11A illustrates a perspective view of an MSCC apparatus 100 about to engage with cart end wall 312 vertical structural tubes 316 of two ODSNUCs 1002. FIG. 11B illustrates a perspective view of the outer face of the MSCC apparatus 100 fully engaged with the vertical structural tubes 316 of the two ODSNUCs 1002. FIG. 11C illustrates a perspective view with transparent components showing the inner face of the MSCC apparatus 100 fully engaged with the two ODSNUCs 1002.

FIG. 11A shows the MSCC apparatus 100 in the pre-engaged position as introduced with respect to FIG. 4A. The retention bolts 110 of the MSCC apparatus 100 may be seen to be above and in alignment with the inner bores 322 of the vertical structural tubes 316 and horizontal cross members 320 of two adjacent cart end walls 312 comprising two adjacent ODSNUCs 1002. Projecting portions of the structural tubes 804 may be seen in this ODSNUC 1002 embodiment.

FIG. 11B shows the MSCC apparatus 100 after the downward motion and inward motion introduced with respect to FIG. 4B have been completed. The retention bolts 110 are not visible in this view as they are fully seated within the inner bores 322 of the horizontal cross members 320 and vertical structural tubes 316 of the cart end walls 312. The projecting portions of the structural tubes 804 may be seen to protrude through the structural tube may be seen to be snapped around and securing the vertical structural tubes 316. The MSCC apparatus 100 thus locks the two adjacent ODSNUCs 1002 together securely, preventing relative horizontal motion, relative vertical motion, and rotation about a vertical axis of the two ODSNUCs 1002 with respect to each other.

FIG. 11C offers another view of the MSCC apparatus 100 fully seated within and locked to the adjacent ODSNUCs 1002. The vertical structural tubes 316 and horizontal cross members 320 are shown as transparent so that the seating of the retention bolts 110 within the inner bores 322 is visible. Both tubing snap clips 124 may be seen to be snapped around and securing the vertical structural tubes 316 of the adjacent ODSNUCs 1002. The projecting portions of the structural tubes 804 of the ODSNUCs 1002 within the vertical structural tubes 316 are accommodated by the end bolt slots 116 with which the retention bolts 110 are configured.

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. Thus, an entity described or recited as “configured to” perform some task refers to something physical. The term “configured to” is not intended to mean “configurable to.” Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of this disclosure as claimed. The scope of disclosed subject matter is not limited to the depicted embodiments but is rather set forth in the following Claims.

What is claimed is:

1. An apparatus for locking adjacent structural tubes together for adjacent tubular structures, the apparatus comprising:
a tube retention body including a pair of substantially parallel retention bolts configured to be inserted in substantially parallel aligned relation within end portions of the adjacent structural tubes and retain the adjacent structural tubes; and
an alignment lock plate pivotally affixed to the tube retention body configured to retain and lock together a pair of the adjacent structural tubes in aligned substantially parallel relation via a toolless connector.

2. The apparatus of claim 1, wherein the alignment lock plate and the tube retention body cooperate to lock the apparatus onto the pair of the adjacent structural tubes constrained in four degrees of freedom.

3. The apparatus of claim 2, wherein the alignment lock plate and the tube retention body cooperate to lock the apparatus from translation in an X axis, a Y axis, and a Z axis, and from rotation about the Z axis of each adjacent structural tube.

4. The apparatus of claim 3, wherein each of the adjacent tubular structures is a cart wall comprising at least one vertical structural tube, and cooperation between the adjacent structural tubes of adjacent cart walls locks the rotation about the Z axis and constrains the adjacent cart walls along a common plane.

5. The apparatus of claim 4, wherein the adjacent cart walls are cart end walls including horizontal cross members, and the alignment lock plate comprises a pair of apertures each configured to interlock with a projecting portion of each horizontal cross member.

6. The apparatus of claim 3, wherein each of the adjacent tubular structures is a cart wall comprising at least one horizontal cross member, and cooperation between the adjacent structural tubes of adjacent cart walls locks the rotation about the Z axis and constrains the adjacent cart walls along a common plane.

7. The apparatus of claim 6, wherein the adjacent cart walls are adjacent cart side walls, and the alignment lock plate comprises a plurality of securement ledges that pass beneath the horizontal cross members of cart end walls connected to the adjacent cart side walls.

8. The apparatus of claim 7, wherein the alignment lock plate includes a pair of apertures each configured to interlock with a projecting portion of the horizontal cross member.

9. The apparatus of claim 1, wherein the toolless connector is a tubing snap clip.

10. A system of joined adjacent tubular structures comprising:
adjacent tubular structures including adjacent structural tubes; and
an apparatus including:
a tube retention body including a pair of substantially parallel retention bolts configured to be inserted in substantially parallel aligned relation within end portions of the adjacent structural tubes and retain the adjacent structural tubes; and
an alignment lock plate pivotally affixed to the tube retention body configured to retain and lock together a pair of the adjacent structural tubes in aligned substantially parallel relation via a toolless connector.

11. The system of claim 10, wherein the alignment lock plate and the tube retention body cooperate to lock the apparatus onto the pair of the adjacent structural tubes constrained in four degrees of freedom.

12. The system of claim 11, wherein the alignment lock plate and the tube retention body cooperate to lock the apparatus from translation in an X axis, a Y axis, and a Z axis, and from rotation about the Z axis of each adjacent structural tube.

13. The system of claim 12, wherein each of the adjacent tubular structures is a cart wall comprising at least one vertical structural tube, and cooperation between the adjacent structural tubes of adjacent cart walls locks the rotation about the Z axis and constrains the adjacent cart walls along a common plane.

14. The system of claim 13, wherein the adjacent cart walls are cart end walls including horizontal cross members, and the alignment lock plate comprises a pair of apertures each configured to interlock with a projecting portion of each horizontal cross member.

15. The system of claim 12, wherein each of the adjacent tubular structures is a cart wall comprising at least one horizontal cross member, and cooperation between the adjacent structural tubes of adjacent cart walls locks the rotation about the Z axis and constrains the adjacent cart walls along a common plane.

16. The system of claim 15, wherein the adjacent cart walls are adjacent cart side walls, and the alignment lock plate comprises a plurality of securement ledges that pass beneath the horizontal cross members of cart end walls connected to the adjacent cart side walls.

17. The system of claim 16, wherein the alignment lock plate includes a pair of apertures each configured to interlock with a projecting portion of the horizontal cross member.

18. The system of claim 1, wherein the toolless connector is a tubing snap clip.

19. A method of joining two adjacent tubular structures, the method comprising:
inserting an apparatus into adjacent structural tubes of the adjacent tubular structures including the adjacent structural tubes, wherein the apparatus includes:
a tube retention body including a pair of substantially parallel retention bolts configured to be inserted in substantially parallel aligned relation within end portions of the adjacent structural tubes and retain the adjacent structural tubes; and
an alignment lock plate pivotally affixed to the tube retention body configured to retain and lock together a pair of the adjacent structural tubes in aligned substantially parallel relation via a toolless connector; and
pressing an inner face of the alignment lock plate flush with the adjacent structural tubes.

20. The method of claim 19, further comprising locking the alignment lock plate to the pair of adjacent structural tubes using tubing snap clips, wherein each toolless connector is a tubing snap clip, and wherein the alignment lock plate and the tube retention body cooperate to lock the adjacent tubular structures onto a pair of adjacent structural tubes constrained in four degrees of freedom.

21. The method of claim 20, wherein the alignment lock plate and the tube retention body cooperate to lock the apparatus from translation in an X axis, a Y axis, and a Z axis, and from rotation about the Z axis of each adjacent structural tube.

22. The method of claim 21, wherein each of the adjacent tubular structures is a cart wall comprising at least one horizontal cross member, and cooperation between the adjacent structural tubes of adjacent cart walls locks the rotation about the Z axis and constrains the adjacent cart walls along a common plane.

23. The method of claim 22, passing a plurality of securement ledges beneath the horizontal cross members of cart end walls connected to adjacent cart side walls, wherein the adjacent cart walls are adjacent cart side walls, and the alignment lock plate comprises the plurality of securement ledges configured to pass beneath the horizontal cross members of the cart end walls connected to the adjacent cart side walls.
